(19) United States
(12) Patent Application Publication
(10) Pub. No.: US 2022/0065658 A1
(43) Pub. Date: Mar. 3, 2022

(54) ERROR DIAGNOSIS DEVICE AND VEHICLE CONTROL DEVICE

(71) Applicant: TOYOTA JIDOSHA KABUSHIKI KAISHA, Toyota-shi (JP)

(72) Inventor: Naoto SUZUKI, Fujinomiya-shi (JP)

(73) Assignee: TOYOTA JIDOSHA KABUSHIKI KAISHA, Toyota-shi (JP)

(21) Appl. No.: 17/404,344

(22) Filed: Aug. 17, 2021

(30) Foreign Application Priority Data
Aug. 26, 2020 (JP) 2020-142808

(51) Int. Cl. G01C 21/00; G07C 5/00; G07C 5/08; G01C 21/34

(52) U.S. Cl. CPC G01C 21/3889; G01C 21/3874; G01C 21/3461; G07C 5/008; G07C 5/0816; G01C 21/3819

(57) ABSTRACT

An error diagnosis device diagnosing if location measurement error has occurred in a location measurement sensor measuring a self-location of a vehicle has a storing part storing map information divided in every road sections; a location acquiring part acquiring self-location information of the vehicle measured by the location measurement sensor; a drive section identifying part identifying road sections on which the vehicle has been driven in the map information, based on the self-location information; and an error diagnosis part. The error diagnosis part judges that there is location measurement error in the location measurement sensor when a first and second road sections of one of the road sections identified as having been driven on by the vehicle are not consecutive, and judges that there is no location measurement error in the location measurement sensor when the first road section and the second road section are consecutive.

### FIELD

The present disclosure relates to an error diagnosis device and vehicle control device.

### BACKGROUND

It has been known in the past to use a GPS receiver or other location measurement sensor to measure a self-location of a vehicle and identify a road on which the vehicle is being driven based on the measured self-location and map information (for example, PTL 1). In particular, in PTL 1, a destination of the vehicle is estimated based on the road identified as being driven on by the vehicle.

### CITATIONS LIST

### Patent Literature

[PTL 1] Japanese Unexamined Patent Publication No. 2010-008330

### SUMMARY

In this regard, if performing control utilizing the self-location of a vehicle measured by a location measurement sensor, it is not possible to suitably perform control if the self-location of the vehicle cannot be accurately measured. For example, in the system such as in PTL 1, if the self-location of the vehicle cannot be accurately measured, the destination of the vehicle is mistakenly estimated. Therefore, it is necessary to diagnose if the self-location of the vehicle is being accurately measured.

In consideration of the above problem, an object of the present disclosure is to provide an error diagnosis device diagnosing if there is location measurement error in measurement of the self-location of the vehicle by the location measurement sensor.

The present invention has as its gist the following.

(1) An error diagnosis device diagnosing if location measurement error has occurred in a location measurement sensor measuring a self-location of a vehicle,

the error diagnosis device comprising:

a storing part storing map information divided in every road sections;

a location acquiring part acquiring self-location information of the vehicle measured by the location measurement sensor;

a drive section identifying part identifying road sections on which the vehicle has been driven in the map information, in time series, based on the self-location information of the vehicle; and

an error diagnosis part judging that there is location measurement error in the location measurement sensor when a first road section of one of the road sections identified as having been driven on by the vehicle and a second road section identified as having been driven on after the first road section is driven on are not consecutive, and judging that there is no location measurement error in the location measurement sensor when the first road section and the second road section are consecutive.

(2) An error diagnosis device diagnosing if location measurement error has occurred in a location measurement sensor measuring a self-location of a vehicle,

the error diagnosis device comprising:

a storing part storing map information divided in every road sections;

a location acquiring part acquiring self-location information of the vehicle measured by the location measurement sensor;

a drive section identifying part identifying road sections on which the vehicle has been driven in the map information, in time series, based on the self-location information of the vehicle; and

an error diagnosis part judging that there is location measurement error in the location measurement sensor when, a ratio of the number of road sections where each section and a road section identified as having been driven on by the vehicle after that road section is driven on are consecutive, with respect to the number of a plurality of road sections identified as having been driven on by the vehicle, is less than a predetermined reference ratio, and judging that there is no location measurement error in the location measurement sensor when that ratio is equal to or greater than the reference ratio.

(3) An error diagnosis device diagnosing if location measurement error has occurred in a location measurement sensor measuring a self-location of a vehicle,

the error diagnosis device comprising:

a storing part storing map information divided in every road sections;

a location acquiring part acquiring self-location information of the vehicle measured by the location measurement sensor;

a drive section identifying part identifying road sections on which the vehicle has been driven in the map information, in time series, based on the self-location information of the vehicle;

a drive distance estimating part estimating a drive distance over which the vehicle has been driven between a first point of time in the past and a second point of time after the first point of time without using the map information; and

an error diagnosis part judging that there is location measurement error in the location measurement sensor when a difference in distance between a total distance of a total of the lengths of all road sections identified as having been driven on by the vehicle from the first point of time to the second point of time and the estimated drive distance is equal to or greater than a predetermined reference value, and judging that there is no location measurement error in the location measurement sensor when the difference in distance is less than the predetermined reference value.

(4) The error diagnosis device according to above (3), wherein the drive distance estimating part estimates the drive distance over which the vehicle has been driven based on a history of self-location information of the vehicle acquired by the location acquiring part.

(5) The error diagnosis device according to above (3), wherein the drive distance estimating part estimates the drive distance over which the vehicle has been driven based on an output of a sensor detecting a speed or acceleration of the vehicle.

(6) The error diagnosis device according to any one of above (1) to (5), wherein the drive section identifying part identifies a road section positioned nearest to a point corresponding to self-location information of the vehicle at any point of time as the road section over which the vehicle has been driven at that point of time.

(7) The error diagnosis device according to above (6), wherein the drive section identifying part does not identify a road section with a start point not matching an end point of another road section or a road section with an end point not matching a start point of another road section among nearby road sections positioned the closest to points corresponding to self-location information of the vehicle at different points of time, as a road section over which the vehicle has been driven.

(8) A control device controlling a vehicle or an equipment mounted in the vehicle,

the control device comprising:

an error diagnosis device according to any one of above (1) to (7);

an estimating part estimating a future state of the vehicle based on a current location of the vehicle; and

a control part controlling the vehicle or the equipment mounted in the vehicle based on the estimated future state, wherein

when it is judged by the error diagnosis device that a location measurement sensor has location measurement error, the estimating part suspends estimation of the future state or the control part controls the vehicle or the equipment mounted in the vehicle not based on the estimated future state.

(9) The control device according to above (8), wherein

the vehicle comprises a motor for driving the vehicle, a rechargeable battery, an internal combustion engine able to charge the battery by its operation, and an electrically heated catalytic device provided in an exhaust passage of the internal combustion engine and heated by being powered, and is configured so that when the battery is to be charged by making the internal combustion engine operate, it heats the catalytic device then starts the internal combustion engine,

the estimating part estimates a future amount of drive energy of the vehicle based on a current self-location of the vehicle, and

the control part judges whether it is necessary to power the catalytic device for starting the internal combustion engine for charging the battery based on the estimated amount of drive energy and current battery state of charge, and starts to power the catalytic device when it is judged that powering the catalytic device is required.

### BRIEF DESCRIPTION OF DRAWINGS

FIG. 1 is a schematic view schematically showing the overall configuration of a vehicle control system.

FIG. 2 is a view schematically showing the configuration of an ego vehicle in the vehicle control system.

FIG. 3 is a schematic view schematically showing the configuration of a server in the vehicle control system.

FIG. 4 is a view schematically showing the configuration of an ECU.

FIG. 5 is a view showing, by the arrows “a” to “d”, examples of typical drive histories in the past when vehicles passing through a certain point A positioned before an intersection are driven for a preheat time T from the point A.

FIG. 6 is a view showing an amount of drive energy Ep corresponding to the preheat time from the point A compared for each drive history.

FIGS. 7A and 7B show a frequency distribution map and cumulative relative frequency distribution of data of the amount of drive energy Ep corresponding to the preheat time from the point A.

FIG. 8 is a view for explaining a technique for a drive section identifying part to identify road sections over which an ego vehicle has been driven, based on self-location information of the ego vehicle.

FIGS. 9A and 9B are views schematically showing histories of points corresponding to self-location information measured by a GPS receiver and road sections identified by the drive section identifying part.

FIG. 10 is a flow chart of processing for error diagnosis for diagnosing whether location measurement error has occurred in the GPS receiver.

FIG. 11 is a view, similar to FIG. 4, schematically showing the configuration of an ECU according to a second embodiment.

FIGS. 12A to 12D are views schematically showing arbitrary regions in the map information stored in a storage device.

FIGS. 13A to 13D are views, similar to FIGS. 12A to 12D, schematically showing arbitrary regions in the map information stored in a storage device

FIG. 14 is a flow chart of processing for error diagnosis for diagnosing whether location measurement error has occurred in the GPS receiver in an error diagnosis part according to the second embodiment.

### DESCRIPTION OF EMBODIMENTS

Below, referring to the drawings, embodiments will be explained in detail. Note that, in the following explanation, similar components will be assigned the same reference notations.

### First Embodiment

Configuration of System

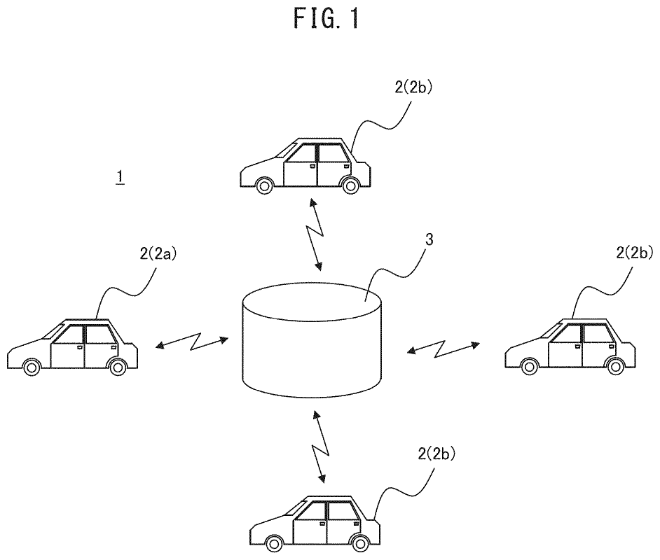

Referring to FIG. 1, a control system according to a first embodiment will be explained. FIG. 1 is a schematic view schematically showing an overall configuration of a vehicle control system 1.

As shown in FIG. 1, the vehicle control system 1 has a plurality of vehicles 2 and a server 3 wirelessly communicating with the vehicles. Each of the vehicles 2 is configured to send drive history information of the vehicle 2 to the server 3 at predetermined timings. The server 3 is configured to be able to store and collect drive history information received from the respective vehicles 2. The server 3 sends information obtained from the data collected at the server 3 to the vehicles 2 in response to requests from the vehicles 2.

In this way, the vehicle control system 1 is configured so that the respective vehicles 2 can provide the server 3 with drive history information of the vehicles 2 and information obtained from data of the drive history information assembled by the server 3 can be utilized by the respective vehicles 2.

Note that, in the following explanation, among the vehicles 2, a vehicle in which the later explained vehicle control, etc., is performed will be referred to as an “ego vehicle 2a” and vehicles other than the ego vehicle 2a will be referred to as “other vehicles 2b”. In the present embodiment, the ego vehicle 2a is a hybrid vehicle or plug-in hybrid vehicle. On the other hand, the other vehicles 2b are not particularly limited in type and may be vehicles other than hybrid vehicles or plug-in hybrid vehicles.

Configuration of Vehicle

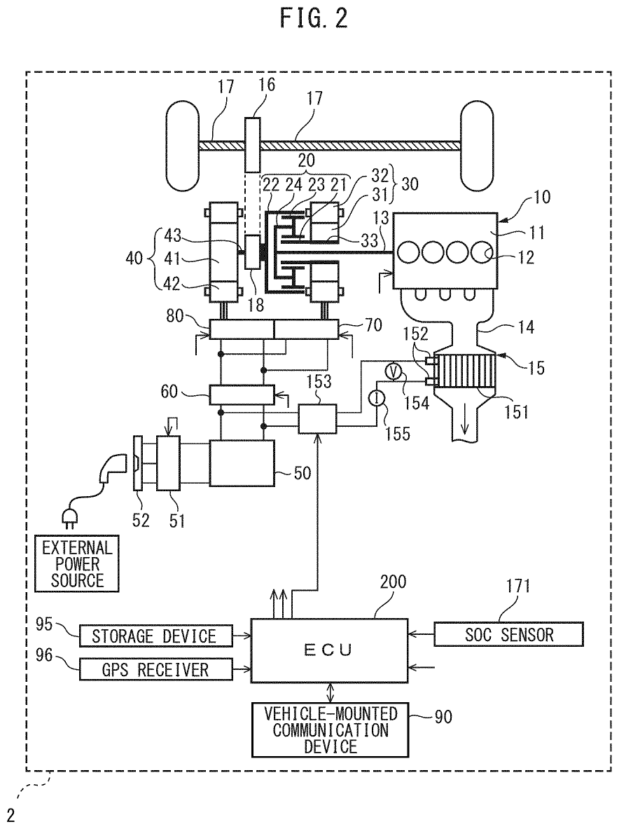

Next, referring to FIG. 2, a vehicle 2 used in the vehicle control system 1 will be explained. FIG. 2 is a view schematically showing the configuration of the ego vehicle 2a in the vehicle control system 1.

The ego vehicle 2a is provided with an internal combustion engine 10, power distribution mechanism 20, first motor-generator (MG) 30, second MG 40, battery 50, boost converter 60, first inverter 70, and second inverter 80. The ego vehicle 2a is driven by drive power of one or both of the internal combustion engine 10 and the second MG 40 being transmitted through a final speed reducer 16 to a wheel drive shaft 17.

The internal combustion engine 10 burns fuel in cylinders 12 formed in the engine body 11 to generate power for making an output shaft 13 turn. The output shaft 13 is connected to the power distribution mechanism 20 and the drive power of the internal combustion engine 10 is transmitted to the wheel drive shaft 17 and the first MG 30, therefore the internal combustion engine 10 can drive the ego vehicle 2a and charge the battery 50 by its operation. The exhaust discharged from cylinders 12 to an exhaust passage 14 flows through the exhaust passage 14 to be discharged into the atmosphere. The exhaust passage 14 is provided with an electrically heated catalytic device 15 for removing harmful substances in the exhaust.

The electrically heated catalytic device 15 is provided with a conductive substrate 151, a pair of electrodes 152, a voltage regulating circuit 153, a voltage sensor 154, and a current sensor 155.

The conductive substrate 151 is, for example, formed by silicon carbide (SiC) or molybdenum disilicide (MoSi₂) or another material generating heat upon being powered. The conductive substrate 151 is formed with a plurality of passages (below, referred to as “unit cells”) of lattice-shaped (or honeycomb-shaped) cross-sections, along the direction of flow of exhaust. A catalyst is carried on the surfaces of the unit cells.

The pair of electrodes 152 are parts for applying voltage to the conductive substrate 151. The pair of electrodes 152 are respectively electrically connected to the conductive substrate 151 and are connected through the voltage regulating circuit 153 to the battery 50. By applying voltage through the pair of electrodes 152 to the conductive substrate 151, current flows through the conductive substrate 151, the conductive substrate 151 generates heat, and thus the catalytic device 15, in particular the catalyst carried on the conductive substrate 151, is heated.

The voltage VH [V] applied by the pair of electrodes 152 to the conductive substrate 151 (below, referred to as the “substrate applied voltage”) can be adjusted by an electronic control unit 200 controlling the voltage regulating circuit 153. By the electronic control unit 200 controlling the voltage regulating circuit 153, the electric power Ph [kW] supplied to the conductive substrate 151 (below, referred to as the “substrate supplied current”) can be controlled to any electric power and, accordingly, the amount of heating of the catalyst can be adjusted. The voltage regulating circuit 153 is controlled so that the substrate applied voltage Vh detected by the voltage sensor 154 becomes a predetermined target voltage or the current Ih [A] flowing through the conductive substrate 151 detected by the current sensor 155 becomes a target current.

The power distribution mechanism 20 is a planetary gear system for dividing the output of the internal combustion engine 10 into two systems of drive power for turning the wheel drive shaft 17 and drive power for driving regenerative operation of the first MG 30. The power distribution mechanism 20 is provided with a sun gear 21, ring gear 22, pinion gears 23, and planetary carrier 24. The sun gear 21 is connected to a rotary shaft 33 of the first MG 30. The ring gear 22 is arranged around the sun gear 21 so as to be positioned concentrically with the sun gear 21, and is connected with a rotary shaft 43 of the second MG 40. Further, at the ring gear 22, a drive gear 18 for transmitting rotation of the ring gear 22 to the final speed reducer 16 is integrally attached. A plurality of pinion gears 23 are arranged between the sun gear 21 and the ring gear 22 so as to engage with the sun gear 21 and the ring gear 22. The planetary carrier 24 is connected to the output shaft 13 of the internal combustion engine 10. Further, the planetary carrier is also connected to the pinion gears 23 so that when the planetary carrier 24 turns, the pinion gears 23 can individually turn (spin) while rotating (orbiting) around the sun gear 21.

The first MG 30 is, for example, a three-phase AC synchronous type motor-generator and is provided with a rotor 31 connected to the rotary shaft 33 and having a plurality of permanent magnets and a stator 32 having an excitation coil generating a rotating magnetic field. The first MG 30 has the function as a motor receiving the supply of electric power from the battery 50 and driving powered operation and the function as a generator receiving drive power of the internal combustion engine 10 and driving regenerative operation. In the present embodiment, the first MG 30 is mainly used as a generator.

The second MG 40 (drive motor) is, for example, a three-phase AC synchronous type motor-generator and is provided with a rotor 41 connected to the rotary shaft 43 and having a plurality of permanent magnets and a stator 42 having an excitation coil generating a rotating magnetic field. The second MG 40 also has functions as a motor and generator.

The battery 50 is, for example, a nickel-cadmium storage battery, a nickel-hydrogen storage battery, a lithium ion battery, or other rechargeable secondary battery. In the present embodiment, as the battery 50, a lithium ion secondary battery is used. The battery 50 is electrically connected through a boost converter 60, etc., to the first MG 30 and the second MG 40 so that the charged electric power of the battery 50 can be supplied to the first MG 30 and the second MG 40 to drive powered operation of the same and further so that the generated electric power of the first MG 30 and the second MG 40 can be charged to the battery 50.

In the present embodiment, the battery 50 is configured for example to be able to be electrically connected to an external power source through a charging control circuit 51 and charging port 52 so as to be able to be charged from a household socket or other external power source. The charging control circuit 51 converts the alternating current supplied from the external power source to direct current able to charge the battery.

Based on a control signal from the electronic control unit 200, the boost converter 60 boosts the terminal voltage of the primary terminal and outputs the boosted voltage from the secondary terminal and, further, lowers the terminal voltage of the secondary terminal and outputs the lowered voltage from the primary terminal. The primary terminal of the boost converter 60 is connected to an output terminal of the battery 50, while the secondary terminal is connected to DC side terminals of the first inverter 70 and the second inverter 80.

The first inverter 70 and the second inverter 80 are respectively provided with electrical circuits enabling them to convert direct current input from the DC side terminals to alternating current (in the present embodiment, three-phase alternating current) and output it from the AC side terminals based on control signals from the electronic control unit 200, and conversely to convert alternating current input from the AC side terminals to direct current and output it from the DC side terminals based on control signals from the electronic control unit 200. The DC side terminal of the first inverter 70 is connected to the secondary terminal of the boost converter 60, while the AC side terminal of the first inverter 70 is connected to the input/output terminal of the first MG 30. The DC side terminal of the second inverter 80 is connected to the secondary terminal of the boost converter 60, while the AC side terminal of the second inverter 80 is connected to the input/output terminal of the second MG 40.

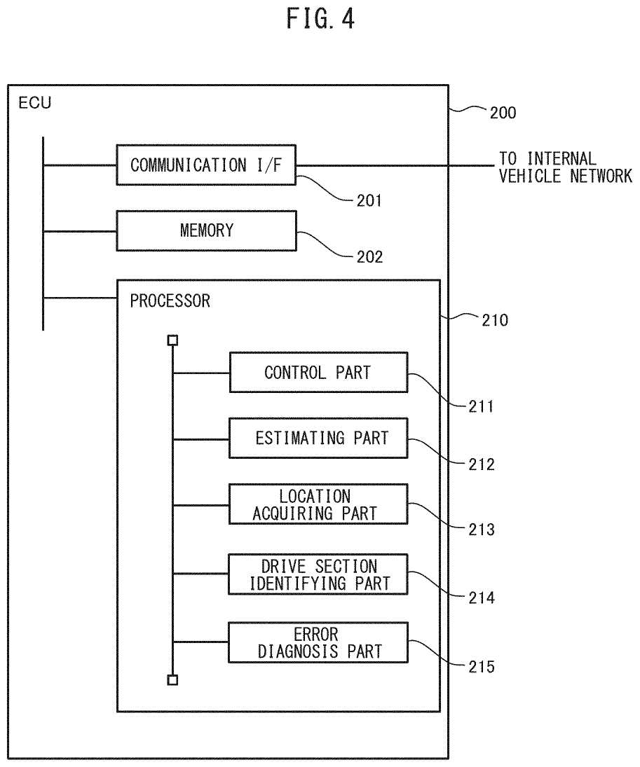

Further, the ego vehicle 2a is provided with the electronic control unit (ECU) 200 and a plurality of sensors connected to the ECU 200. FIG. 4 is a view schematically showing the configuration of the ECU 200. As shown in FIG. 4, the ECU 200 is provided with a communication interface 201 connected through a CAN or other internal vehicle network, with various actuators (for example, an actuator for driving the throttle valve of the internal combustion engine 10 or the inverters 70 and 80) or various sensors, a memory 202 storing programs or various types of information, and a processor 210 performing various processing. The communication interface 201, memory 202, and processor 210 are connected with each other through signal wires. The ECU 200 functions as a vehicle control device controlling the actuators of the ego vehicle 2a to control the ego vehicle 2a, and functions as an error diagnosis device diagnosing the presence of error of the later explained location measurement sensor.

The ECU 200 is connected to various sensors in addition to the above-mentioned voltage sensor 154 or current sensor 155. For example, the ECU 200 is connected to an SOC sensor 171 for detecting a state of charge (SOC) of the battery 50 or sensors for detecting the demanded output to the internal combustion engine 10 or the rotational speed of the internal combustion engine 10 or other parameters required for control of the internal combustion engine 10 and receives as input the output signals from these sensors. The ECU 200 controls the various actuators of the ego vehicle 2a based on the output signals from these various sensors.

In addition, the ego vehicle 2a, as shown in FIG. 2, is provided with a vehicle-mounted communication device 90, the storage device 95 and GPS receiver 96. The vehicle-mounted communication device 90 is configured to be able to wirelessly communicate with a server communication device 301 of the server 3. The vehicle-mounted communication device 90 sends drive history information of the ego vehicle 2a sent from the electronic control unit 200, to the server 3. Further, the vehicle-mounted communication device 90 may also receive map information on the surroundings of the ego vehicle 2a from the server 3 and send it the storage device 95.

The storage device 95, for example, has a hard disk drive or a nonvolatile semiconductor memory. The storage device 95 is one example of a storing part storing map information. In particular, in the present embodiment, map information is stored for each predetermined section of a road. The road sections are, for example, obtained by dividing the road by intersections. Further, in roads with no intersections over long distances, the road sections are obtained by dividing the road by fixed distances. Therefore, the road sections show sections of a road with no branching or merging parts between one intersection and its adjoining intersection or sections of a road with no branching or merging parts over a certain distance. Therefore, the map information includes locations of road sections, lengths (distances) of road sections, and information showing road signs relating to the road sections (for example, lanes, dividing lines, or stop lines). The storage device 95 reads out map information in accordance with read requests for map information from the ECU 200 and sends the map information to the ECU 200.

The GPS receiver 96 is one example of a location measurement sensor measuring a self-location of the ego vehicle 2a. The GPS receiver 96 receives GPS signals from three or more GPS satellites and measures the self-location (longitude and latitude) of the ego vehicle 2a based on the received GPS signals. The GPS receiver 96 outputs the measurement results of the self-location of the ego vehicle 2a to the ECU 200 every predetermined cycle. Note that, as long as the self-location of the ego vehicle 2a can be measured, another location measurement sensor may also be used instead of the GPS receiver 96.

Configuration of Server

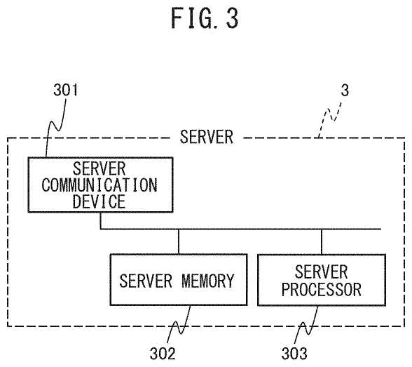

FIG. 3 is a view schematically showing the configuration of the server 3 in the vehicle control system 1. As shown in FIG. 3, the server 3 is provided with a server communication device 301, server memory 302, and server processor 303. The server communication device 301, server memory 302, and server processor 303 are connected to each other through signal wires.

The server communication device 301 is configured to be able to wirelessly communicate with the vehicle-mounted communication devices 90 of the vehicles 2 (ego vehicle 2a and other vehicles 2b). The server communication device 301 sends various types of information sent from the server processor 303 in response to requests from the vehicles 2 to the vehicles 2, and sends drive history information received from the vehicles 2 to the server processor 303.

The server memory 302 has a hard disk drive, optical storage medium, semiconductor memory, or other storage medium, and stores programs to be executed at the server processor 303. Further, the server memory 302 stores data generated by the server processor 303, drive information received by the server processor 303 from the vehicles 2, etc. The server processor 303 executes computer programs for control and processing at the server 3.

Vehicle Control

Next, the vehicle control performed by the ECU 200, in particular the control of the drive mode of the ego vehicle 2a, will be explained. As shown in FIG. 4, the processor 210 of the ECU 200 has the two functional blocks of a control part 211 and an estimating part 212, relating to control of the ego vehicle 2a.

The control part 211 of the ECU 200 according to the present embodiment sets the drive mode of the ego vehicle 2a to the either of the EV (electrical vehicle) mode and CS (charge sustaining) mode, based on the state of charge of the battery 50. Specifically, the control part 211 sets the drive mode of the ego vehicle 2a to the EV mode, when the state of charge of the battery 50 is equal to or greater than a mode switching charge level SC1 and sets the drive mode of the ego vehicle 2a to the CS mode when the state of charge of the battery 50 is less than the mode switching charge level SC1. The mode switching charge level SC1 may be a predetermined constant value (for example, 10% of state of full charge) or for example may be a value changing in accordance with the demanded output of the ego vehicle 2a (for example, proportional to amount of depression of accelerator pedal) etc.

The EV mode is a mode where the ego vehicle 2a is driven by the second MG 40. When the drive mode of the ego vehicle 2a is set to the EV mode, the control part 211 makes the internal combustion engine 10 stop and utilizes the electric power charged in the battery 50 to drive the second MG 40 for powered operation. The ego vehicle 2a is driven by the drive power of the second MG 40.

On the other hand, CS mode is a mode where the ego vehicle 2a is driven by the internal combustion engine 10 and the first MG 30 charges the battery 50. When the drive mode of the ego vehicle 2a is set to the CS mode, the control part 211 makes the internal combustion engine 10 operate, divides the drive power of the internal combustion engine 10 by the power distribution mechanism 20, conveys one part of the divided drive power to the wheel drive shaft 17, and uses the other part of the divided drive power to drive regenerative operation of the first MG 30 to make it generate electric power. The ego vehicle 2a is driven by the drive power of the internal combustion engine 10 and the drive power of the second MG 40 driven by electric power supplied from the first MG 30.

When the drive mode of the ego vehicle 2a is switched from the EV mode to the CS mode, the internal combustion engine 10 is started up. If the internal combustion engine 10 is started up, exhaust gas is discharged from the cylinders 12 of the engine body 11 to the exhaust passage 14. Here, to purify the exhaust gas in the catalytic device 15, the temperature of the catalytic device 15 has to be equal to or greater than an activation temperature of the catalyst (for example, 300° C.). For this reason, when switching the drive mode of the ego vehicle 2a from the EV mode to the CS mode for charging the battery 50 by driving the internal combustion engine 10, it is necessary to make the temperature of the catalytic device 15 rise in advance so that the temperature of the catalytic device 15 becomes equal to or greater than the activation temperature before the startup of the internal combustion engine 10. Therefore, in the present embodiment, when switching the drive mode from the EV mode to the CS mode, the conductive substrate 151 starts to be powered, that is, the catalytic device 15 starts to be raised in temperature, after the state of charge of the battery 50 detected by the SOC sensor falls to a warmup start charge level SC2 greater than the mode switching charge level SC1 so as to start up the internal combustion engine 10 after the catalytic device 15 has finished being heated. By electrically heating the catalytic device 15 during the EV mode before startup of the internal combustion engine 10 as preheating and finishing warming up the catalytic device 15 in advance in this way, it is possible to keep the exhaust emission from deteriorating.

In this regard, if the catalytic device 15 starts to be heated too early, the time from when the temperature of the catalytic device 15 reaches the activation temperature to when the internal combustion engine 10 is started up will be longer, and therefore wasteful energy will be required for maintaining the catalytic device 15 at a high temperature. On the other hand, if the catalytic device 15 starts to be heated too late, the internal combustion engine 10 will be started up in a state where the catalytic device 15 has not been sufficiently raised in temperature, and therefore the exhaust emission will deteriorate. For this reason, to keep down consumption of wasteful energy and deterioration of the exhaust emission, it is necessary to start heating the catalytic device 15 at a suitable timing. For this reason, it is necessary to set the warmup start charge level SC2 at a suitable value.

Therefore, in the present embodiment, the control part 211 sets the warmup start charge level SC2 based on the following formula (1).

SC2=Eh+Ep+SC1 (1)

In the above formula (1), Eh is the amount of energy [kWh] required for raising the temperature of the catalytic device 15 up to the activation temperature. Eh is calculated by multiplying a preheat time T with the electric power supplied to the substrate. Further, in the above formula (1), Ep is the amount of energy [kWh] required for driving equipment (for example, the second MG 40) other than the catalytic device 15 in the interval until making the catalytic device 15 rise in temperature to the activation temperature (preheat time T). To calculate Ep, it becomes necessary to estimate the amount of energy required until the preheat time T elapses from the current time. Ep is calculated by the estimating part 212 of the ECU 200.

The estimating part 212 estimates a future state of the ego vehicle 2a based on the current self-location of the ego vehicle 2a measured by the GPS receiver 96. Below, the technique by which the estimating part 212 estimates a future state of the ego vehicle 2a, in particular the amount of drive energy from the present until the preheat time T elapses, will be explained.

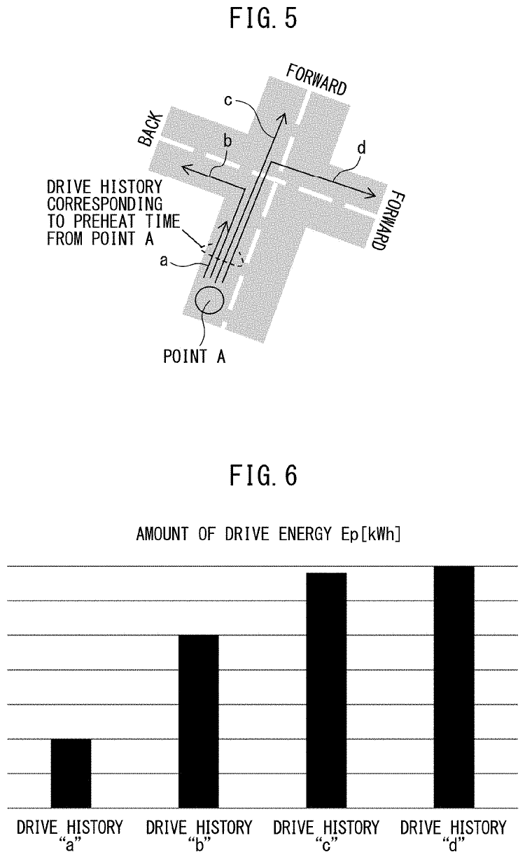

FIG. 5 is a view showing by the arrow marks “a” to “d” examples of typical drive histories when vehicles 2 passing a certain point A before an intersection are driven for the preheat time T from the point A. FIG. 6 is a view showing the amount of drive energy Ep corresponding to the preheat time from the point A in comparison with each drive history.

In FIG. 5, the drive history “a” shows the drive history in the case where the signal of the intersection is a red light and the vehicle is driven by a low load while stopping at the intersection, while the drive histories “b” to “d” show drive histories in the case where the signal at the intersection is a green light and the vehicle passes through the intersection to turn left, go straight, or turn right at the intersection. As shown in FIG. 5, there are various drive histories in the case where vehicles 2 passing a point A in the past drove from the point A by the preheat time T. Therefore, as shown in FIG. 6, the amount of drive energy Ep corresponding to the preheat time from the point A also differs for each drive history. In the example shown in FIG. 6, the drive energy becomes larger in the order of the drive histories “a”, “b”, “c”, and “d”. In this way, the drive load Pp changes in various ways according to the drive route from the point A and the traffic situation, therefore it is difficult to precisely estimate the amount of drive energy Ep corresponding to the preheat time from the point A.

Therefore, in the present embodiment, it is made possible to collect drive history information of different vehicles 2 and calculate a value suitable as the amount of drive energy Ep corresponding to the preheat time from the current self-location of each vehicle 2 based on data summarizing that drive history information.

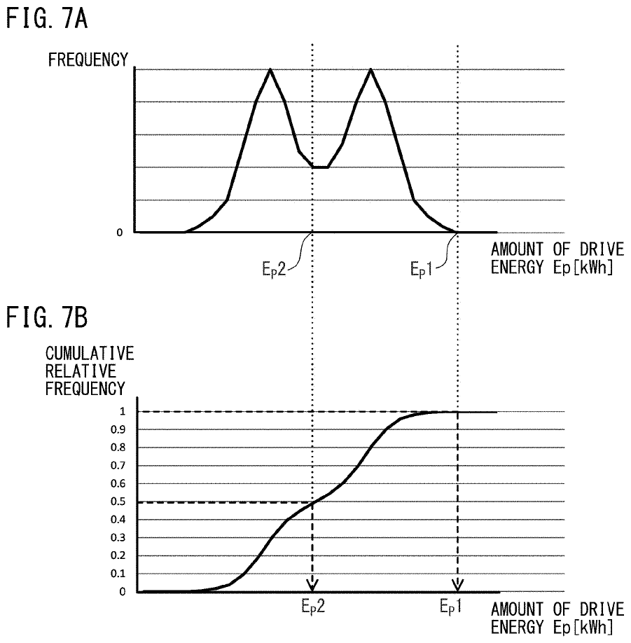

FIG. 7A is a view showing the data of the amounts of drive energy EP, corresponding to the preheat time from the point A, of vehicles 2 passing through the point A in the past, as a frequency distribution map, the amounts of drive energy Ep being calculated based on the drive history information of the different vehicles 2, while FIG. 7B is a view showing the data on the amounts of drive energy Ep as the cumulative relative frequency distribution.

In FIG. 7B, if designating the amount of drive energy when the cumulative relative frequency becomes 1 as Ep 1, the cumulative relative frequency being 1 indicates that among the vehicles 2 passing the point A in the past, the ratio of the vehicles 2 driven for the preheat time T from the point A by amounts of drive energy equal to or less than the amount of drive energy Ep1 is 1. That is, it indicates that among the vehicles 2 passing the point A in the past, all vehicles 2 were driven for the preheat time T from the point A by amounts of drive energy equal to or less than the amount of drive energy Ep1.

Further, if designating the amount of drive energy when the cumulative relative frequency becomes 0.5 as Ep2, the cumulative relative frequency being 0.5 indicates that among the vehicles 2 passing the point A in the past, the ratio of the vehicles 2 driven for the preheat time T from the point A by amounts of drive energy equal to or less than the amount of drive energy Ep2 is 0.5. That is, it indicates that among the vehicles 2 passing the point A in the past, half of the vehicles 2 were driven for the preheat time T from the point A by amounts of drive energy equal to or less than the amount of drive energy Ep2.

Therefore, the cumulative relative frequency in FIG. 7B can be said to express the probability of any amount of drive energy being consumed when a vehicle 2 is driven for the preheat time T from the point A. Therefore, if in this way putting together the data on the amounts of drive energy Ep corresponding to the preheat time from a certain point of vehicles 2 passing the certain point in the past, as the distribution of cumulative relative frequency, it is possible to enter the amount of drive energy Ep(a) with a cumulative relative frequency of a in the above-mentioned formula (1) to set the warmup start charge level SC2 and thereby successfully preheat by a probability of generally a when starting preheating from a certain point.

Therefore, in the present embodiment, the server 3 calculates the amounts of drive energy Ep corresponding to the preheat time from different points on a road based on the drive history information sent from a plurality of vehicles 2, and puts together the data on the amount of drive energy Ep for each point as the distribution of cumulative relative frequency.

Further, the estimating part 212 of the ECU 200 sends the self-location of the ego vehicle 2a measured by the GPS receiver 96 to the server 3, and receives the distribution data such as shown in FIG. 7B at that position from the server 3. Further, the estimating part 212 calculates an estimated value of the amount of drive energy Ep (below, the “estimated amount of drive energy Epest”) by which the probability of the preheating being finished within the preheat time T becomes equal to or greater than a predetermined probability, when starting preheating from a certain point on a road based on the received distribution data. Specifically, when desiring to find the estimated amount of drive energy Epest corresponding to the preheat time from a certain point on a road, the estimating part 212 refers to the distribution data obtained by putting together the data of the amount of drive energy Ep corresponding to the preheat time from that point as the distribution of cumulative relative frequency, and calculates, as the estimated amount of drive energy Epest, the amount of drive energy Ep where the probability of successful preheating will be a predetermined probability αs (0≤αs≤1), that is, the amount of drive energy Ep(αs) of the time when the cumulative relative frequency a is a predetermined cumulative relative frequency as. Note that, in the present embodiment, the cumulative relative frequency αs is a fixed value, but for example may also be a variable value corresponding to the shape, etc., of the frequency distribution map of FIG. 7A.

Due to this, if setting the cumulative relative frequency as to, for example, a value close to 1, it is possible to complete warmup of the catalytic device 15 by a high probability in the period during the battery state of charge SC falling from the warmup start charge level SC2 to the mode switching charge level SC1. Further, conversely, by making the cumulative relative frequency as for example approach 0 from 1, it is possible to keep the time from when the catalytic device 15 finishes being warmed up to when the battery state of charge SC falls to the mode switching charge level SC1, from becoming too long.

In the present embodiment, the control part 211 enters the estimated amount of drive energy Epest calculated in the above way into formula (1) as Ep to thereby calculate the warmup start charge level SC2. Further, as explained above, the control part 211 judges if the state of charge of the battery 50 detected by the SOC sensor is equal to or less than the calculated warmup start charge level SC2, that is, if it is necessary to power the catalytic device 15 toward starting up the internal combustion engine 10 for starting to charge the battery. Further, if it is judged that the detected state of charge of the battery 50 is equal to or less than the warmup start charge level SC2, that is, if it is judged that the catalytic device 15 has to be powered, the control part 211 starts to power the catalytic device 15, that is, to raise the temperature of the catalytic device 15, in preparation for change of the drive mode from the EV mode to the CS mode. That is, in the present embodiment, the control part 211 controls the catalytic device 15, which is an equipment mounted in the ego vehicle 2a (or the ego vehicle 2a itself) based on an estimated future state.

Note that, in the above embodiment, the estimating part 212 estimates the amount of drive energy from the current time to when the preheat time T elapses as a future state of the ego vehicle 2a. However, if there is a future state of the ego vehicle 2a which can be estimated based on the current self-location of a vehicle, the estimating part 212 may also estimate as the future state of the ego vehicle 2a, for example, a point estimated to be reached by the ego vehicle 2a after a predetermined time, or other parameter. Further, in the present embodiment, the control part 211 controls the catalytic device 15 based on the estimated future state. However, the control part 211 may also control equipment mounted in the ego vehicle 2a other than the catalytic device 15 (for example, a navigation system) based on a future state. Alternatively, the control part 211 may control the ego vehicle 2a itself (for example, if the ego vehicle 2a is a self driving vehicle, acceleration/deceleration or steering) based on a future state.

In this regard, if a large location measurement error occurs in the GPS receiver 96, the self-location of the ego vehicle 2a measured by the GPS receiver 96 will greatly deviate from the actual self-location. In such a case, even if estimating the future state of the ego vehicle 2a based on the self-location of the ego vehicle 2a measured by the GPS receiver 96, it is not possible to accurately estimate it. Therefore, in the present embodiment, if it is judged that location measurement error has occurred in the GPS receiver 96, the estimating part 212 suspends future estimation. In this case, when calculating the warmup start charge level SC2 in the above formula (1), a predetermined constant value is entered for Ep.

Alternatively, if it is judged that location measurement error has occurred in the GPS receiver 96, when calculating the warmup start charge level SC2 in the above formula (1), the control part 211 may use a predetermined constant value as the amount of drive energy Ep without using the amount of drive energy estimated by the estimating part 212 (that is, the estimated future state). In this case, the control part 211 controls the catalytic device 15, which is an equipment mounted in the ego vehicle 2a (or the ego vehicle 2a itself) without being based on a future state estimated by the estimating part 212.

Error Diagnosis of Location Measurement Sensor

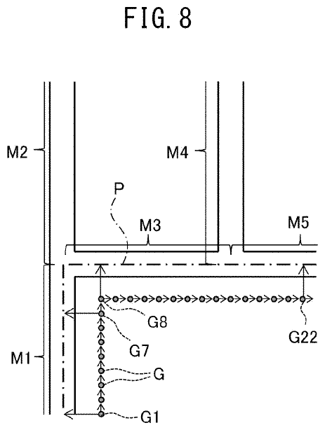

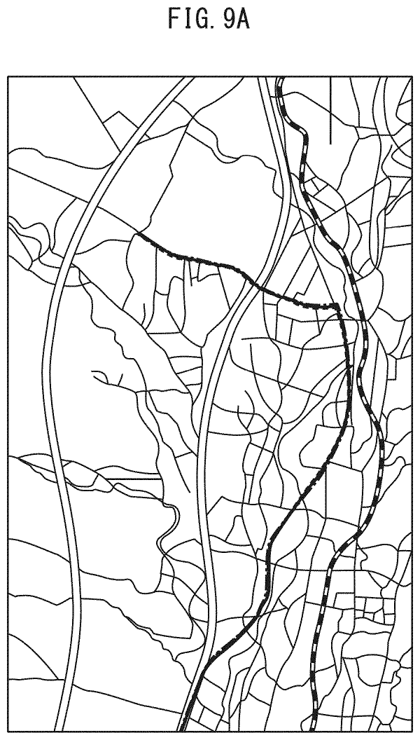

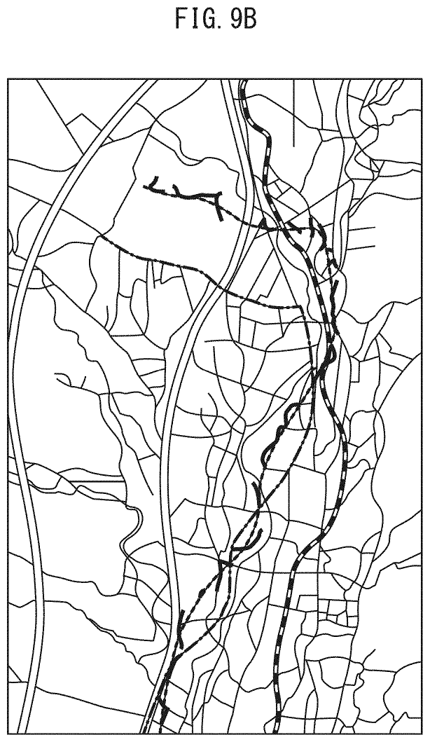

Next, referring to FIGS. 8, 9A, and 9B, error diagnosis for diagnosing the presence of any location measurement error of the GPS receiver 96 functioning as the location measurement sensor will be explained. The error diagnosis is performed by the ECU 200. The ECU 200, as shown in FIG. 4, is provided with a location acquiring part 213, drive section identifying part 214, and error diagnosis part 215 in relation to error diagnosis.

The location acquiring part 213 acquires the self-location information of the ego vehicle 2a measured by the GPS receiver 96. The location acquiring part 213 acquires the self-location information of the ego vehicle 2a every predetermined cycle at which measurement results of the self-location are sent from the GPS receiver 96. The self-location information, for example, includes information on the longitude and latitude of the ego vehicle 2a when measurement was performed by the GPS receiver 96.

The drive section identifying part 214 identifies by time series the road sections on which the ego vehicle 2a has been driven in the map information stored in the storage device 95, based on the self-location information of the ego vehicle 2a acquired by the location acquiring part 213. The method of identification of the road sections by the drive section identifying part 214 will be specifically explained.

FIG. 8 is a view for explaining the technique by which the drive section identifying part 214 identifies road sections on which the ego vehicle 2a has been driven based on self-location information of the ego vehicle 2a. FIG. 8 schematically shows any region in the map information stored in the storage device 95. In particular, in the region shown in FIG. 8, five road sections M1 to M5 are included.

On the other hand, the points G in FIG. 8 show by time series the points on the map information corresponding to the self-location information of the ego vehicle 2a measured by the GPS receiver 96. The arrow marks between the points G show the order in which the points G were measured. Therefore, the point G1 corresponds to the self-location information first measured by the GPS receiver 96 in the region shown in FIG. 8, while the point G22 corresponds to the self-location information last measured by the GPS receiver 96 in the region shown in FIG. 8.

In the present embodiment, the drive section identifying part 214 identifies the road section positioned closest to the point corresponding to the self-location information of the ego vehicle 2a acquired by the location acquiring part 213 at a certain point of time, as the road section on which the ego vehicle 2a was driving at that point of time. Therefore, when the point on the map information corresponding to the self-location information of the ego vehicle 2a measured by the GPS receiver 96 is G1, the road section M1 is identified as the road section on which the ego vehicle 2a was being driven at that point of time. Similarly, when the points corresponding to the self-location information of the ego vehicle 2a measured by the GPS receiver 96 are G7, G8, and G22, the road sections M1, M3, M5 are identified as the road sections on which the ego vehicle 2a was being driven at those points of time.

The error diagnosis part 215 judges whether location measurement error has occurred in the GPS receiver 96, that is, the location measurement sensor. In the present embodiment, the error diagnosis part 215 diagnoses if the location measurement error has occurred, based on the self-location information measured by the GPS receiver 96 and the road sections on which the ego vehicle 2a has been driven identified by the drive section identifying part 214.

In this regard, in the GPS receiver 96 or other location measurement sensor, sometimes the measured self-location deviates from the actual self-location. In particular, if, due to battery replacement, etc., corrective information on location in the GPS receiver 96 is reset, the location measurement error of the GPS receiver 96 will be larger, and in some cases error of several km or so will occur. In such a case, the road sections identified by the drive section identifying part 214 will be different from the road sections on which the ego vehicle 2a has actually been driven.

FIGS. 9A and 9B are views schematically showing histories of points corresponding to the self-location information measured by the GPS receiver 96 and the road sections identified by the drive section identifying part 214. In FIGS. 9A and 9B, the one-dot chain lines shows the actual drive routes of the ego vehicle 2a, the broken lines shows the routes followed by the points corresponding to the self-location information of the ego vehicle 2a measured by the GPS receiver 96 (below, referred to as the “measured routes”), and the solid lines show the road sections identified based on the self-location information of the ego vehicle 2a.

FIG. 9A shows the case where there is almost no location measurement error in the GPS receiver 96. In this case, the actual drive route of the vehicle 2a (one-dot chain line), the measured route (broken line) and road sections identified as ones on which the ego vehicle 2a has been driven (solid line) are substantially matched with each other. For this reason, in the example shown in FIG. 9A, the one-dot chain line, broken line, and solid line overlap.

On the other hand, FIG. 9B shows the case where there is large location measurement error in the GPS receiver 96. In particular, in the example shown in FIG. 9B, the self-location of the ego vehicle 2a measured by the GPS receiver 96 deviates from the actual location of the ego vehicle 2a to the north side (in FIG. 9B, the upper side). As will be understood from FIG. 9B, if the self-location measured by the GPS receiver 96 greatly deviates from the actual self-location, the measured route (broken lines) will greatly shift from the location of the road on the map. As a result, the road sections identified by the drive section identifying part 214 (solid line) will show road sections of the road different from the road sections on which the ego vehicle 2a has actually been driven. In such a case, usually, there is no road running along the measured route (broken line), therefore as shown in FIG. 9B, the drive section identifying part 214 identifies nonconsecutive road sections separated from each other as road sections on which the ego vehicle 2a has been driven. In other words, if there is large location measurement error in the GPS receiver 96, the identified road sections are not consecutive.

Therefore, in the present embodiment, the error diagnosis part 215 judges that there is large location measurement error in the GPS receiver 96 when the ratio of the number of road sections where a road section and a road section identified as having been driven on by the ego vehicle 2a after the road section have been driven on are consecutive, with respect to the number of the road sections identified by the drive section identifying part 214, is less than a predetermined reference ratio, and judges that there is no large location measurement error in the GPS receiver 96 when that ratio is equal to or greater than the reference ratio. Here, the reference ratio is, for example, set to the minimum value which the ratio can take when there is no large location measurement error in the GPS receiver 96.

Specifically, in the present embodiment, the error diagnosis part 215 judges, for each of the road sections identified by the drive section identifying part 214 from any past start point of time to end point of time, whether the start point of that road section matches the end point of the road section identified as one on which the ego vehicle 2a has been driven before that road section was driven on. Further, the error diagnosis part 215 calculates, among all road sections from any start point of time to end point of time, the number of road sections where the start points of certain road sections and end points of the preceding road sections match. Further, it calculates the value of the calculated number of road sections divided by the number of all road sections from any start point of time to end point of time as the ratio of the consecutive road sections. The error diagnosis part 215 compares the calculated ratio and a reference ratio to judge if any location measurement error has occurred.

As a result, as shown in FIG. 9A, if no large location measurement error has occurred in the GPS receiver 96, the ratio of consecutive road sections is larger than the reference ratio and accordingly it is judged that the location measurement error is small. On the other hand, as shown in FIG. 9B, if large location measurement error has occurred in the GPS receiver 96, the ratio of consecutive road sections is smaller than the reference ratio and accordingly it is judged that the location measurement error is large. In this way, according to the present embodiment, it is possible to suitably detect if large location measurement error has occurred in the GPS receiver 96.

Note that, in the above embodiment, the error diagnosis part 215 diagnoses location measurement error based on three or more road sections identified as ones on which the ego vehicle 2a has been driven. However, the error diagnosis part 215 may also diagnose location measurement error based on two road sections. In this case, the error diagnosis part 215 judges that there is location measurement error in the location measurement sensor if one of the road sections identified as ones on which the ego vehicle 2a has been driven, that is, a first road section, and a second road section estimated as having been driven on after that first road section was driven on are not consecutive, and judges that there is no location measurement error in the location measurement sensor if the first road section and the second road section are consecutive.

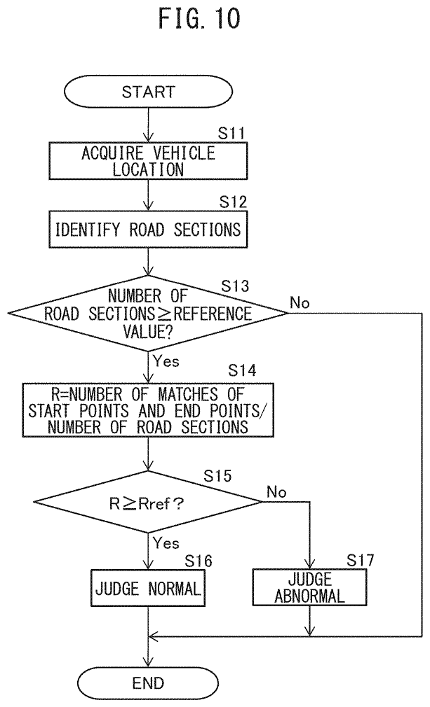

FIG. 10 is a flow chart of error diagnosis processing for diagnosing if location measurement information has occurred in the GPS receiver 96. The error diagnosis processing illustrated is performed at the processor 210 of the ECU 200 every certain time interval.

As shown in FIG. 10, first, at step S11, the location acquiring part 213 acquires the current self-location information of the ego vehicle 2a from the GPS receiver 96. Next, at step S12, the drive section identifying part 214 identifies the road section over which the ego vehicle 2a is currently driving, based on the current self-location information, and stores the identified road section in the memory 202 of the ECU 200.

Next, at step S13, the error diagnosis part 215 judges if the number of road sections stored in the memory 202 from any start point of time (for example, point of time of start of storing road sections) is equal to or greater than a predetermined constant reference value. If at step S13 it is judged that the number of road sections is less than the reference value, the control routine is ended. On the other hand, if at step S13 it is judged that the number of road sections is equal to or greater than the reference value, the control routine proceeds to step S14.

At step S14, the error diagnosis part 215 calculates the ratio of the number of the road sections where the start points of certain road sections and the end points of the preceding road sections match, with respect to the number of all of the road sections from any start point of time stored in the memory 202, as the ratio R of consecutive road sections. Next, at step S15, the error diagnosis part 215 judges if the ratio R of the consecutive road sections is equal to or greater than a predetermined reference ratio Rref. If at step S15 it is judged that the ratio R of consecutive road sections is equal to or greater than the reference ratio, the control routine proceeds to step S16 where the error diagnosis part 215 judges that GPS receiver 96 is normal. On the other hand, if at step S15 it was judged that the ratio R of consecutive road sections is less than the reference ratio, the control routine proceeds to step S17 where the error diagnosis part 215 judges that there is an abnormality in the GPS receiver 96, that is, the location measurement error is large.

### Second Embodiment

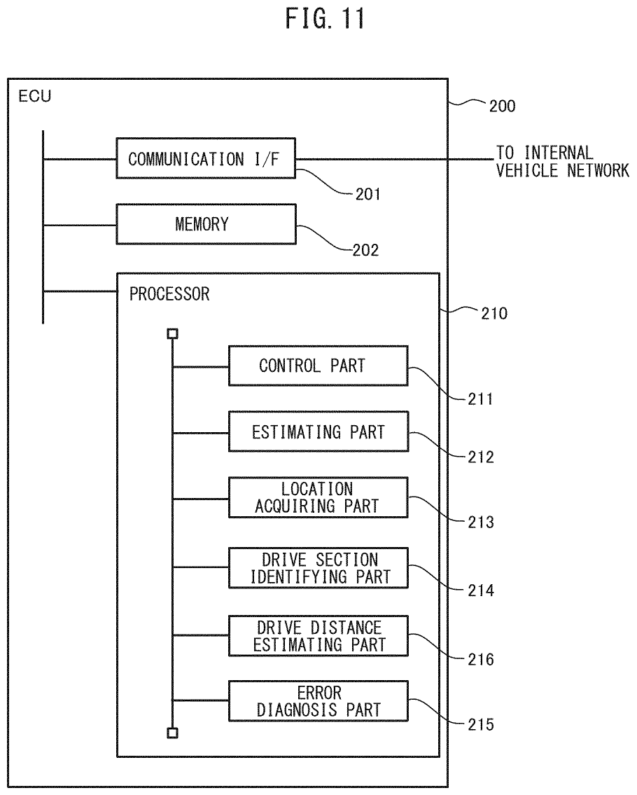

Next, referring to FIGS. 11 to 14, a vehicle control system according to a second embodiment will be explained. Below, the parts different from the first embodiment will be focused on in the explanation. In the above first embodiment, the error diagnosis part 215 judges if any location measurement error has occurred based on whether the start points and end points of the road sections identified by the drive section identifying part match. As opposed to this, in the second embodiment, the error diagnosis part 215 judges if any location measurement error has occurred based on the drive distances corresponding to the road sections identified by the drive section identifying part 214.

FIG. 11 schematically shows the configuration of the ECU 200 according to the second embodiment, and is similar to FIG. 4. As shown in FIG. 11, in the present embodiment, the ECU 200 is provided with a drive distance estimating part 216 in addition to the location acquiring part 213, drive section identifying part 214, and error diagnosis part 215, in relation to error diagnosis.

The drive distance estimating part 216 estimates a drive distance over which the ego vehicle 2a has driven from a certain start point of time in the past (first point of time) to an end point of time after that certain start point of time (second point of time) without using map information. Specifically, in the present embodiment, the drive distance estimating part 216 estimates the drive distance over which the ego vehicle 2a has driven based on the history of self-location information of the ego vehicle 2a measured by the GPS receiver 96 and acquired by the location acquiring part 213. In particular, in the present embodiment, the drive distance estimating part 216 calculates the length of the route which the points corresponding to the self-location information of the ego vehicle 2a acquired in this way follow, as the drive distance over which the ego vehicle 2a has driven.

For example, in the example shown in FIG. 9B, as explained above, the broken line shows a route corresponding to the self-location information of the ego vehicle 2a measured by the GPS receiver 96. As will be understood from FIG. 9B, the broken line deviates from the one-dot chain line showing the actual drive route of the ego vehicle 2a, but basically has substantially the same shape of route as the actual drive route. Therefore, the length of the route shown by the broken line in FIG. 9B is substantially equal to the length of the actual drive route of the ego vehicle 2a. Therefore, by finding the length of the route which the points corresponding to the self-location information of the ego vehicle 2a measured by the GPS receiver 96 follow, it is possible to relatively accurately estimate the drive distance over which the ego vehicle 2a has been driven.

Note that, the drive distance estimating part 216 may also use another method to estimate the drive distance over which the ego vehicle 2a has been driven. For example, if sensors (not shown) detecting the speed or acceleration of the ego vehicle 2a are provided at the ego vehicle 2a, the drive distance of the ego vehicle 2a may be estimated based on the outputs of these sensors. Specifically, for example, it is possible to find the drive distance of the ego vehicle 2a by integrating the speed of the ego vehicle 2a from the first point of time to the second point of time.

In the present embodiment as well, the error diagnosis part 215 judges whether a large location measurement error has occurred in the GPS receiver 96. Here, as will be understood from FIG. 9B, if a large location measurement error has occurred in the GPS receiver 96, the road sections identified by the drive section identifying part 214 (solid line) show road sections of roads different from the road on which the ego vehicle 2a has been actually driven. As a result, the total distance of all of the identified road sections differs from the actual drive distance.

Therefore, in the present embodiment, the error diagnosis part 215 acquires the lengths of the road sections (distances) for all of the road sections identified by the drive section identifying part 214 on which the ego vehicle 2a has been driven from a certain start point of time in the past (first point of time) to an end point after that certain point of time (second point of time), and totals up the lengths of all of the road sections acquired to calculate the total distance. Further, the error diagnosis part 215 compares the drive distance from the start point of time to the end point of time estimated by the drive distance estimating part 216 and the total distance calculated as explained above. If the difference in distance between the drive distance and the total distance is equal to or greater than a predetermined reference value, it judges that there is a large location measurement error in the GPS receiver 96, while if the difference in distance is less than the reference value, it judges that there is no location measurement error in the GPS receiver 96. Here, the reference value is, for example, set to the maximum value which the difference in distance can take when there is no large location measurement error in the GPS receiver 96.

As a result, as shown in FIG. 9A, if no large location measurement error occurs in the GPS receiver 96, the difference in distance is small and accordingly it is judged that the location measurement error is small. On the other hand, as shown in FIG. 9B, if large location measurement error occurs in the GPS receiver 96, the difference in distance is large and accordingly it is judged that the location measurement error is large. In this way, according to the present embodiment, it is possible to suitably detect if large location measurement error has occurred in the GPS receiver 96.

In this regard, in the first embodiment, the drive section identifying part 214 identifies a road section positioned closest to the point corresponding to the self-location information of the ego vehicle 2a acquired by the location acquiring part 213 at a certain point of time as the road section on which the ego vehicle 2a has been driven at that point of time. However, if identifying the road section on which the ego vehicle 2a has been driven in this way, if location measurement error occurs even slightly in the GPS receiver 96, the drive section identifying part 214 identifies a road section on which the ego vehicle 2a has not actually been driven as the road section on which the ego vehicle 2a has been driven. .

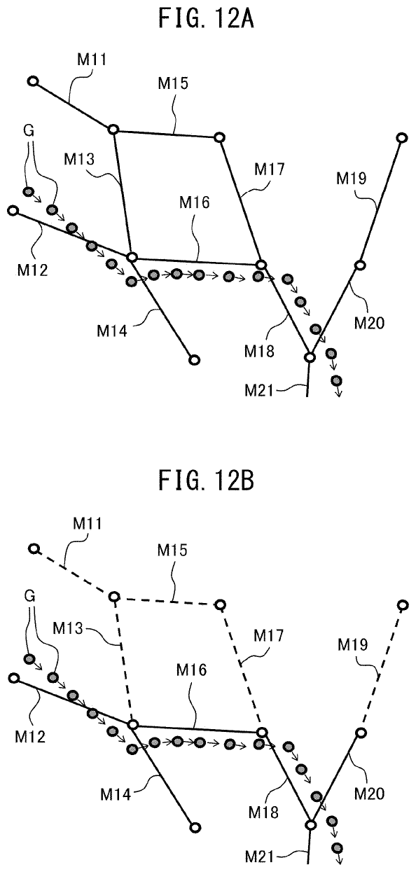

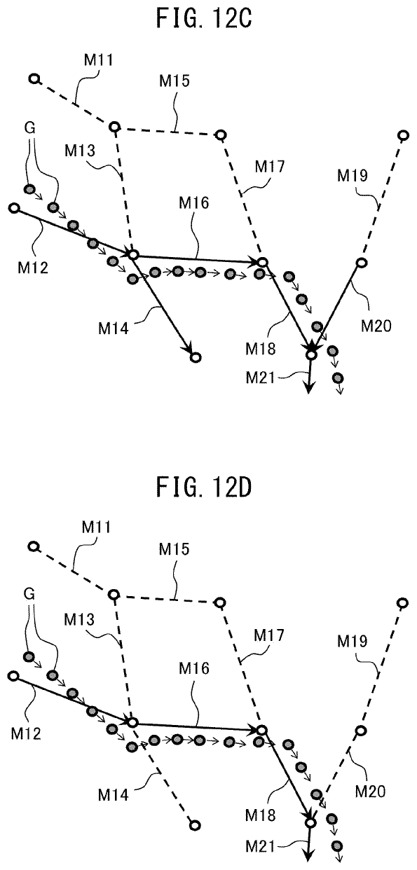

FIGS. 12A to 12D are views schematically showing arbitrary region of the map information stored in the storage device 95. In particular, the region shown in FIGS. 12A to 12D includes a large number of road sections M11 to M21. Further, the points G of FIGS. 12A to 12D, in the same way as FIG. 8, show by time series the points of the map information corresponding to the self-location information of the ego vehicle 2a measured by the GPS receiver 96.

FIG. 12A is a view simply adding points corresponding to self-location information of the ego vehicle 2a measured by the GPS receiver 96 to the road sections in the map information. Some location measurement error occurs in the GPS receiver 96, but it will be understood from FIG. 12A that the road sections on which the ego vehicle 2a has actually been driven are the road sections M12, M16, M18, and M21.

FIG. 12B is a view showing the road sections positioned closest to the points corresponding to the self-location information of the ego vehicle 2a measured by the GPS receiver 96 (below, referred to as “nearby road sections”). The solid lines in the figure show road sections corresponding to nearby road sections, while the broken lines in the figure show road sections not corresponding to nearby road sections. In the example shown in FIG. 12B, the road sections M12, M14, M16, M18, M20, and M21 correspond to nearby road sections. For this reason, the nearby road sections include the road sections M14 and M20 on which the ego vehicle 2a has not actually been driven.

Therefore, in the present embodiment, the drive section identifying part 214 does not identify a road section with a start point not matching an end point of another road section or a road section with an end point not matching a start point of another road section among the nearby road sections, as a road section on which the vehicle has been driven.

Specifically, the drive section identifying part 214 identifies the directions of advance of the ego vehicle 2a of the nearby road sections M12, M14, M16, M18, M20, and M21. The directions of advance of the ego vehicle 2a at the nearby road sections are, for example, identified based on the history of the points corresponding to the self-location information of the ego vehicle 2a. Specifically, the directions of advance of the ego vehicle 2a at the nearby road sections are identified as directions similar to the directions in which the points corresponding to the self-location information of the ego vehicle 2a (directions shown by arrow marks between points G in the figure) move. As a result, the directions of advance of the ego vehicle 2a at the nearby road sections are identified as shown in FIG. 12C. FIG. 12C is a view showing the directions of advance of the ego vehicle 2a at the road sections for the nearby road sections shown in FIG. 12B. The arrow marks of the road sections of FIG. 12C show the directions identified as the directions of advance of the ego vehicle 2a at the road sections.

Next, the drive section identifying part 214 judges for the respective nearby road sections M12, M14, M16, M18, M20, and M21 whether the start points match the end points of other nearby road sections and whether the end points match the start points of other nearby road sections. Further, the drive section identifying part 214 identifies nearby road sections with start points matching end points of other nearby road sections and with end points matching start points of other nearby road sections as road sections on which the ego vehicle 2a has been driven. Conversely, the drive section identifying part 214 does not identify nearby road sections with start points not matching end points of other nearby road sections and with end points not matching start points of other nearby road sections as road sections on which the ego vehicle 2a has been driven.

FIG. 12D is a view showing the thus finally identified road sections on which the ego vehicle 2a has been driven. In FIG. 12D, the solid lines show the road sections identified as road sections on which the ego vehicle 2a has been driven, while the broken lines show road sections not identified as road sections on which the ego vehicle 2a has been driven. As will be understood from FIG. 12D, the road section M14 does not have an end point matching a start point of another nearby road section. Further, the road section M20 does not have a start point matching with an end point of another nearby road section. Therefore, these road sections M14 and M20 are not identified as road sections on which the ego vehicle 2a has been driven. As a result, as will be understood from FIG. 12D, the road sections on which the ego vehicle 2a has actually been driven are identified as the road sections on which the ego vehicle 2a has been driven.

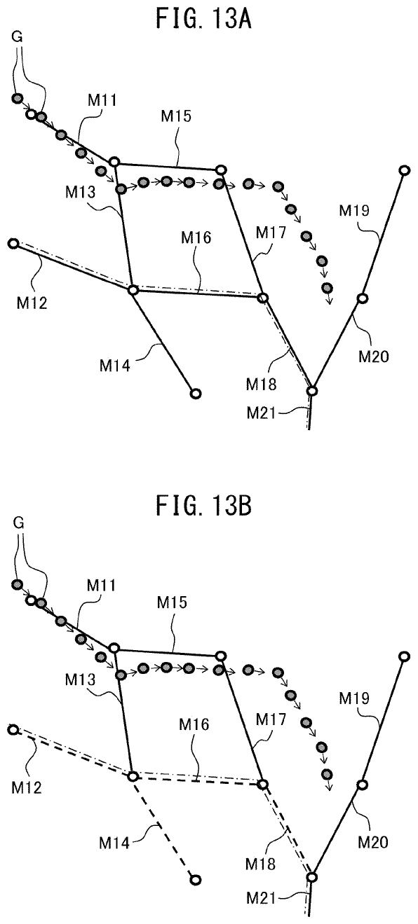

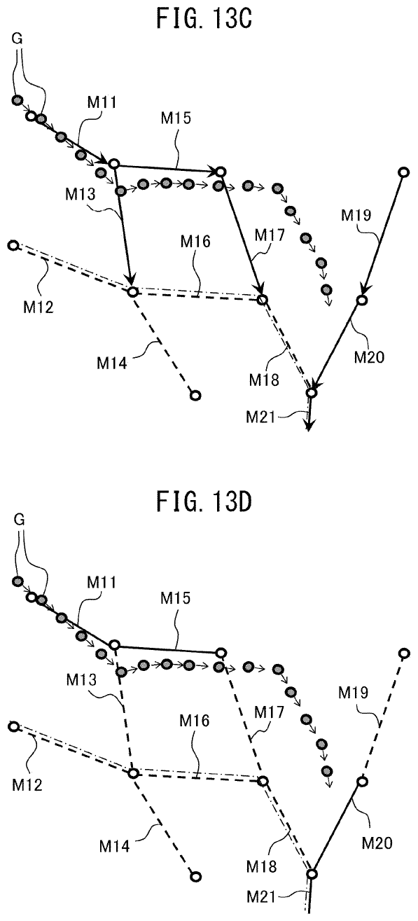

FIGS. 13A to 13D are views, similar to FIGS. 12A to 12D, schematically showing an arbitrary region in the map information stored in the storage device 95. FIGS. 13A to 13D show the case where the location measurement error of the GPS receiver 96 is large. The actual drive path of the ego vehicle 2a is shown in the figures by broken lines. FIG. 13A is a view, similar to FIG. 12A, simply adding to the road sections in the map information the points corresponding to the self-location information of the ego vehicle 2a measured by the GPS receiver 96. FIG. 13B is a view, similar to FIG. 12B, showing the nearby road sections. FIG. 13C is a view, similar to FIG. 12C, showing the directions of advance of the ego vehicle 2a at the different road sections for the nearby road sections shown in FIG. 13B. FIG. 13D is a view, similar to FIG. 12D, showing the finally identified road sections on which the ego vehicle 2a has been driven. As will be understood from FIG. 13D, the road sections identified as having been driven on by the ego vehicle 2a are road sections greatly different from the road sections on which the ego vehicle 2a has actually been driven. As a result, the total distance of the total of the distances of all of the road sections identified differs from the actual drive distance.

Note that, the method of identifying road sections on which the ego vehicle 2a has been driven such as shown in FIGS. 12A to 13D may be used in the error diagnosis device according to the first embodiment as well.

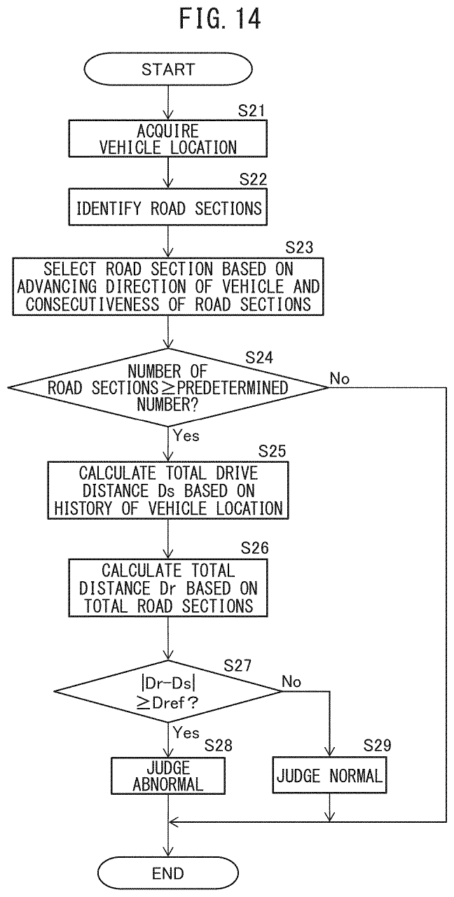

FIG. 14 is a flow chart of processing for error diagnosis for diagnosing whether location measurement error has occurred in the GPS receiver 96 in the error diagnosis part 215 according to the second embodiment. Steps S21 to S22 and S24 in FIG. 14 are similar to steps S11 to S13 in FIG. 10, therefore explanations will be omitted.

At step S23, the drive section identifying part 214 selects road sections based on the directions of advance of the vehicle and the consecutiveness of road sections. That is, the operation explained using FIGS. 12C and 12D is performed. Specifically, the direction of advance of the ego vehicle in each road section is identified based on the direction in which the points corresponding to the self-location information of the ego vehicle 2a move and the road sections with consecutiveness are selected based on the match of the start points and end points of the different drive sections and other drive sections.

At step S25, the drive distance estimating part 216 calculates a total drive distance Ds in a time period based on a history of self-location information of the ego vehicle 2a measured by the GPS receiver 96 from any start point of time to end point of time stored in the memory 202. Next, at step S26, the error diagnosis part 215 totals up the lengths of all road sections identified as having been driven on by the ego vehicle 2a from any start point of time to end point of time in the road sections selected at step S23 to calculate a total distance Dr.

Next, at step S27, the error diagnosis part 215 judges if the difference in distance between the total drive distance Ds and total distance Dr is equal to or greater than a reference value Dref. If it is judged that the difference in distance is equal to or greater than the reference value Dref, the control routine proceeds to step S28 where the error diagnosis part 215 judges that the GPS receiver 96 is abnormal, that is, that the location measurement error is large. On the other hand, if at step S27 it is judged that the difference in distance is less than the reference value Dref, the control routine proceeds to step S28 where the error diagnosis part 215 judges that the GPS receiver 96 is normal.

1. An error diagnosis device diagnosing if location measurement error has occurred in a location measurement sensor measuring a self-location of a vehicle, the error diagnosis device comprising:
a memory storing map information divided in every road sections; and
a processor, wherein
the processor is configured to:
acquire self-location information of the vehicle measured by the location measurement sensor;
identify road sections on which the vehicle has been driven in the map information, in time series, based on the self-location information of the vehicle; and
judge that there is location measurement error in the location measurement sensor when a first road section of one of the road sections identified as having been driven on by the vehicle and a second road section identified as having been driven on after the first road section is driven on are not consecutive, and judge that there is no location measurement error in the location measurement sensor when the first road section and the second road section are consecutive.

2. An error diagnosis device diagnosing if location measurement error has occurred in a location measurement sensor measuring a self-location of a vehicle,
the error diagnosis device comprising:
a memory storing map information divided in every road sections; and
a processor, wherein
the processor is configured to:
acquire self-location information of the vehicle measured by the location measurement sensor;
identify road sections on which the vehicle has been driven in the map information, in time series, based on the self-location information of the vehicle; and
judge that there is location measurement error in the location measurement sensor when, a ratio of the number of road sections where each section and a road section identified as having been driven on by the vehicle after that road section is driven on are consecutive, with respect to the number of a plurality of road sections identified as having been driven on by the vehicle, is less than a predetermined reference ratio, and judge that there is no location measurement error in the location measurement sensor when that ratio is equal to or greater than the reference ratio.

3. An error diagnosis device diagnosing if location measurement error has occurred in a location measurement sensor measuring a self-location of a vehicle,
the error diagnosis device comprising:
a memory storing map information divided in every road sections; and
a processor, wherein
the processor is configured to:
acquire self-location information of the vehicle measured by the location measurement sensor;
identify road sections on which the vehicle has been driven in the map information, in time series, based on the self-location information of the vehicle;
estimate a drive distance over which the vehicle has been driven between a first point of time in the past and a second point of time after the first point of time without using the map information; and
judge that there is location measurement error in the location measurement sensor when a difference in distance between a total distance of a total of the lengths of all road sections identified as having been driven on by the vehicle from the first point of time to the second point of time and the estimated drive distance is equal to or greater than a predetermined reference value, and judge that there is no location measurement error in the location measurement sensor when the difference in distance is less than the predetermined reference value.

4. The error diagnosis device according to claim 3, wherein the processor is configured to estimate the drive distance over which the vehicle has been driven based on a history of self-location information of the vehicle acquired by the location acquiring part.

5. The error diagnosis device according to claim 3, wherein the processor is configured to estimate the drive distance over which the vehicle has been driven based on an output of a sensor detecting a speed or acceleration of the vehicle.

6. The error diagnosis device according to claim 1, wherein the processor is configured to identify a road section positioned nearest to a point corresponding to self-location information of the vehicle at any point of time as the road section over which the vehicle has been driven at that point of time.

7. The error diagnosis device according to claim 6, wherein the processor is configured not to identify a road section with a start point not matching an end point of another road section or a road section with an end point not matching a start point of another road section among nearby road sections positioned the closest to points corresponding to self-location information of the vehicle at different points of time, as a road section over which the vehicle has been driven.

8. A control device controlling a vehicle or an equipment mounted in the vehicle,
the control device comprising:
an error diagnosis device according to claim 1; and
a processor, wherein
the processor of the control device is configured to:
estimate a future state of the vehicle based on a current location of the vehicle; and
control the vehicle or the equipment mounted in the vehicle based on the estimated future state,
the processor is configured to the processor suspend estimation of the future state or control the vehicle or the equipment mounted in the vehicle not based on the estimated future state, when it is judged by the error diagnosis device that a location measurement sensor has location measurement error.

9. The control device according to claim 8, wherein
the vehicle comprises a motor for driving the vehicle, a rechargeable battery, an internal combustion engine able to charge the battery by its operation, and an electrically heated catalytic device provided in an exhaust passage of the internal combustion engine and heated by being powered, and is configured so that when the battery is to be charged by making the internal combustion engine operate, it heats the catalytic device then starts the internal combustion engine,
the processor of the control device is configured to estimate a future amount of drive energy of the vehicle based on a current self-location of the vehicle, and
the processor of the control device is configured to judge whether it is necessary to power the catalytic device for starting the internal combustion engine for charging the battery based on the estimated amount of drive energy and current battery state of charge, and start to power the catalytic device when it is judged that powering the catalytic device is required.
